(19) United States
(12) Patent Application Publication
(10) Pub. No.: US 2008/0130011 A1
(43) Pub. Date: Jun. 5, 2008

(54) Transmissive disk, manufacturing method thereof, and levitation measurement apparatus using transmissive disk

(75) Inventor: Daisuke Kimura, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/894,220

(22) Filed: Aug. 20, 2007

(30) Foreign Application Priority Data
Nov. 30, 2006 (JP) 2006-322821

(51) Int. Cl. G01B 11/02; B05D 5/06

(52) U.S. Cl. 356/498; 427/165

(57) ABSTRACT

To provide a transmissive disk which is less subject to damage and whose levitation amount can be measured up to a smaller level with high accuracy, a manufacturing method thereof, and a levitation measurement apparatus using the transmissive disk.

A transmissive disk for use in head levitation measurement in the present invention has a first side of a transmissive plate to which AR coating has been applied and a second side thereof to which lubricant coating has been applied.

### BACKGROUND OF THE INVENTION

1. Field of the Invention

The present invention relates to a transmissive disk for use in head levitation measurement, a manufacturing method thereof, and a levitation measurement apparatus using the transmissive disk.

2. Description of the Related Art

There is known a levitation measurement apparatus for measuring a levitation amount of a head of a magnetic disk drive, which uses, e.g., a glass disk as a transmissive disk. In the levitation measurement apparatus, a measurement method using Phase shift is now replacing a conventional method that uses the amount of interference light along with a reduction in the head levitation amount and in order to increase measurement accuracy.

In levitation measurement using the amount of interference light, a head needs to be lift up in a state where the head levitation amount is extremely small (several nm) relative to the glass disk at the calibration time. At this time, a head levitation state becomes unstable, which may cause the head to be brought into contact with the surface of the glass disk to scratch the surface thereof. As a countermeasure against this problem, there is known a technique in which a lubricant is coated on one side surface of the glass disk (refer to, e.g., Patent Document 1: Jpn. Pat. Appln. Laid-Open Publication No. 63-281284).

With the development of technology, the levitation amount of a head of a magnet disk drive has become smaller. Further, along with a reduction in the head levitation amount in order to increase the measurement accuracy, laser light needs to be used in a Phase shift measurement using the amount of interference light. In this case, however, reflection of the leaser light by the upper surface of the glass disk influences Phase shift. To avoid this, AR coating is applied to the glass disk, while the lubricant used in the measurement using the amount of interference light was regarded as hindrance rather than a help to an increase in measurement accuracy and has not been used recently. As a technique in which AR coating is applied to the glass disk or glass surface, Jpn. Pat. Appln. Laid-Open Publication Nos. 11-54053 (Patent Document 2) and 2003-151111 (Patent Document 3) are known.

However, in a measurement method using conventional Phase shift, AR coating is applied to one side of the glass disk, so that only the other side on which AR coating is not applied can be used as a measurement surface in the head levitation amount measurement. Thus, the glass disk becomes unavailable with slight damage. Further, when it is necessary to measure up to a smaller levitation amount, a head and glass disk are brought into contact with each other due to surface undulation, making it impossible to obtain an accurate levitation amount.

A lubricant to be coated for protecting damage, which has conventionally been used, was regarded as hindrance to an increase in measurement accuracy and has not been used recently.

However, the present inventor has found a new way to perform measurement using Phase shift. That is, a lubricant is coated on one surface of the glass surface and AR coating is applied to the other side thereof. The measurement result revealed that it is possible not only to prevent disk damage but also to measure up a levitation amount to a smaller level with high accuracy.

### SUMMARY OF THE INVENTION

The present invention has been made to solve the above problems, and an object thereof is to provide a transmissive disk which is less subject to damage and whose levitation amount can be measured up to a smaller level with high accuracy, a manufacturing method thereof, and a levitation measurement apparatus using the transmissive disk.

To solve the above problem, according to a first aspect of the present invention, there is provided a transmissive disk for use in head levitation measurement, wherein the transmissive disk has a first side of a transmissive plate to which AR coating has been applied and a second side thereof to which lubricant coating has been applied.

According to a second aspect of the present invention, there is provided a manufacturing method of a transmissive disk for use in head levitation measurement, comprising: applying AR coating to a first side of a transmissive plate; and applying lubricant coating to a second side thereof.

According to a second aspect of the present invention, there is provided a levitation measurement apparatus that performs head levitation measurement, comprising: a transmissive disk; a projector that is disposed opposite to a first side of the transmissive disk and projects light, through the transmissive disk, to a head levitated from a second side of the transmissive disk; and a measurement section that uses interference between light which is projected from the projector and reflected by the second side of the transmissive disk and light reflected by the head to measure a distance between the head and transmissive disk as a head levitation amount, the transmissive disk having the first side of a transmissive plate to which AR coating has been applied and second side thereof to which lubricant coating has been applied.

According to the present invention, it is possible to provide a transmissive disk which is less subject to damage and to measure levitation amount up to a smaller level with high accuracy using the transmissive disk.

### BRIEF DESCRIPTION OF THE DRAWINGS

FIG. 1 is a side view showing a glass disk which is a transmissive disk according to a first embodiment of the present invention;

FIG. 2 is a side view showing a glass disk which is a transmissive disk according to a second embodiment of the present invention;

FIG. 3 is a block diagram showing the entire configuration of a magnetic head levitation amount measurement apparatus;

FIG. 4 is a partially enlarged view of FIG. 3 which shows a measurement principle according to a third embodiment of the present invention;

FIG. 5 is a graph showing a comparison between the glass disk according to the first embodiment and a conventional glass disk (typical disk) to which Lub coating has not been applied, with respect to a relationship between the peripheral speed of the glass disk and head levitation amount; and

FIG. 6 is a table showing a comparison between the glass disk 1 according to a present embodiment and a typical disk, with respect to N vale (reflectance) and K value (attenuation rate).

### DETAILED DESCRIPTION OF THE PREFERRED EMBODIMENTS

Embodiments of the present invention will be described below with reference to the accompanying drawings.

### First Embodiment

FIG. 1 is a side view showing a glass disk which is a transmissive disk according to a first embodiment of the present invention.

A glass disk 1 has a first side 1a of a disk (glass plate GP which is a transmissive plate) to which AR coating 1b has been applied and a second surface 1c thereof to which Lub (lube) coating 1d which is lubricant coating has been applied.

The AR coating 1b has been known as surface treatment applied to a glass such as a lens or display (CRT) and is treated with special surface treatment in order to suppress reflection of indoor lighting or outside light in the display surface of a CRT. In this first embodiment, two types of thin films having different refractive indexes are coated on the surface of the first side 1a of the glass disk 1 to thereby prevent reflection of outside light in the display surface. The AR coating 1b has a film thickness determined by the refractive indexes of materials used and wavelength of light to be transmitted and thereby transmits only the wavelength used to determine the film thickness.

The Lub coating 1d is known as a fluorinated lubricant. In the first embodiment, the Lub coating 1d has a film thickness of, e.g., 1 nm.

### Second Embodiment

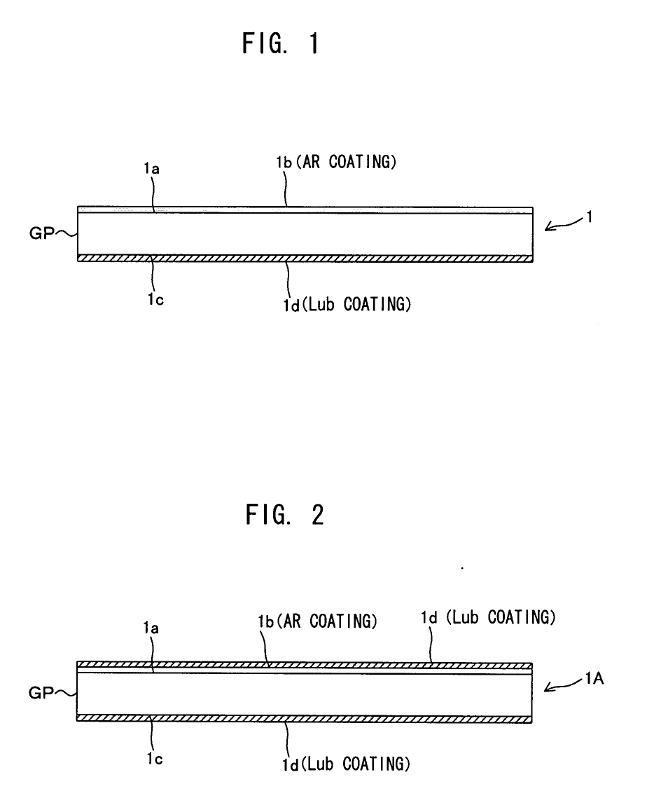

FIG. 2 is a side view showing a glass disk which is a transmissive disk according to a second embodiment of the present invention.

In a glass disk 1A according to the second embodiment, the Lub coating 1d which is the same as the Lub coating 1d shown in the first embodiment is applied to the upper surface of the first side 1a of the glass disk according to the first embodiment to which the AR coating 1b has been applied.

The AR coating 1b is applied to the first side 1a of the a disk (glass plate GP) as a glass disk in the case of the first embodiment and then the entire disk is immersed in the lubricant (Lub) to obtain the glass disk 1A according to the second embodiment. According to the above manufacturing method, it is possible to extremely easily achieve Lub coating as well as to prevent both side surfaces of the glass disk 1 from being damaged.

### Third Embodiment

In a third embodiment, a head (e.g., magnetic head) levitation measurement apparatus using the glass disk according to the first or second embodiment will be described.

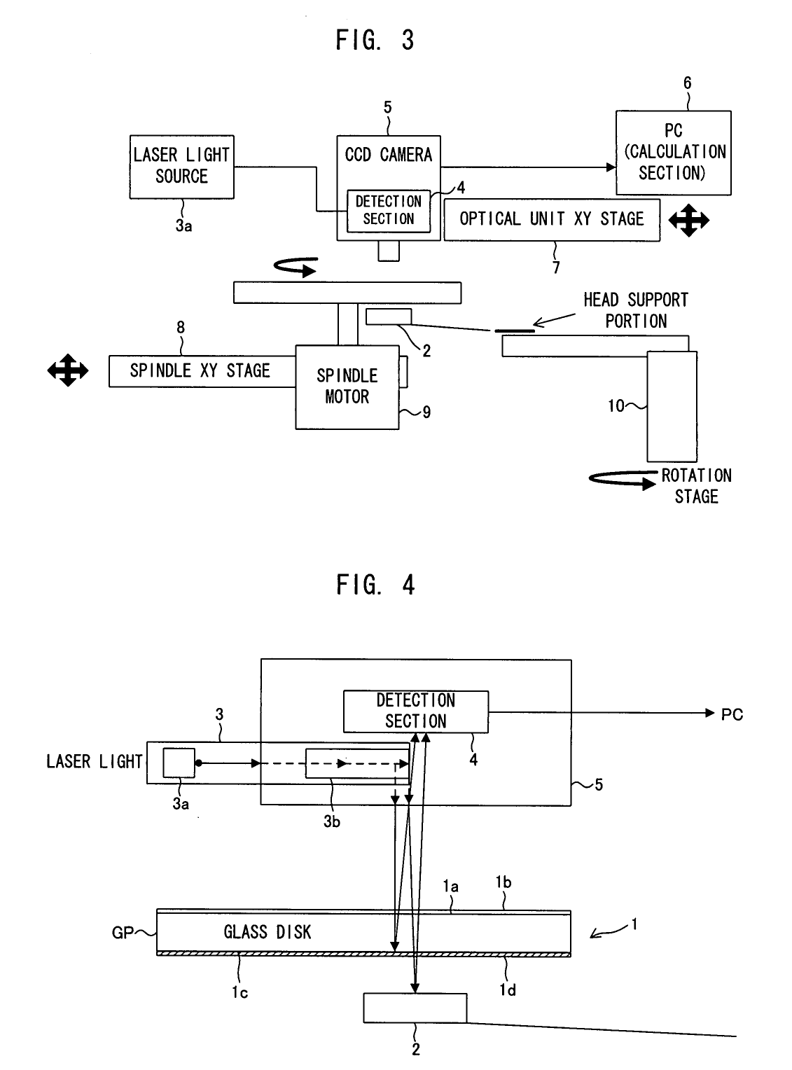

FIG. 3 is a block diagram showing the entire configuration of a magnetic head levitation amount measurement apparatus, and FIG. 4 is a partially enlarged view of FIG. 3 which shows a measurement principle.

The levitation measurement apparatus shown in FIG. 3 includes the glass disk 1 (1A) which is a transmissive disk according to the first embodiment (or second embodiment), a projector 3, a CCD camera 5, and a calculation section (PC) 6. The projector 3 is disposed opposite to the first side 1a of the glass disk 1A and includes a laser light source 3a and an optical system 3b which project light, through the glass disk 1, to a magnetic head 2 (slider) which is levitated from the surface of the second side 1c of the glass disk 1. The CCD camera 5, which includes a detection section 4 which detects interference between light which is projected from the projector 3 and reflected by the surface of the second side 1c of the glass disk 1 and light reflected by the magnetic head 2, and picks up the interference. The calculation section 6 uses Phase shift method to perform levitation amount calculation based on an output of the CCD camera 5.

The CCD camera 5 including the detection section 4 and calculation section 6 constitute a measurement section of the present invention.

The CCD camera 5 is placed on an optical unit XY stage 7 which drives an optical unit. The glass disk 1 is rotated by a spindle motor 9 fitted to a spindle XY stage 8. The magnetic head (slider) 2 is supported by a head support portion 10 rotated by a not shown rotation stage.

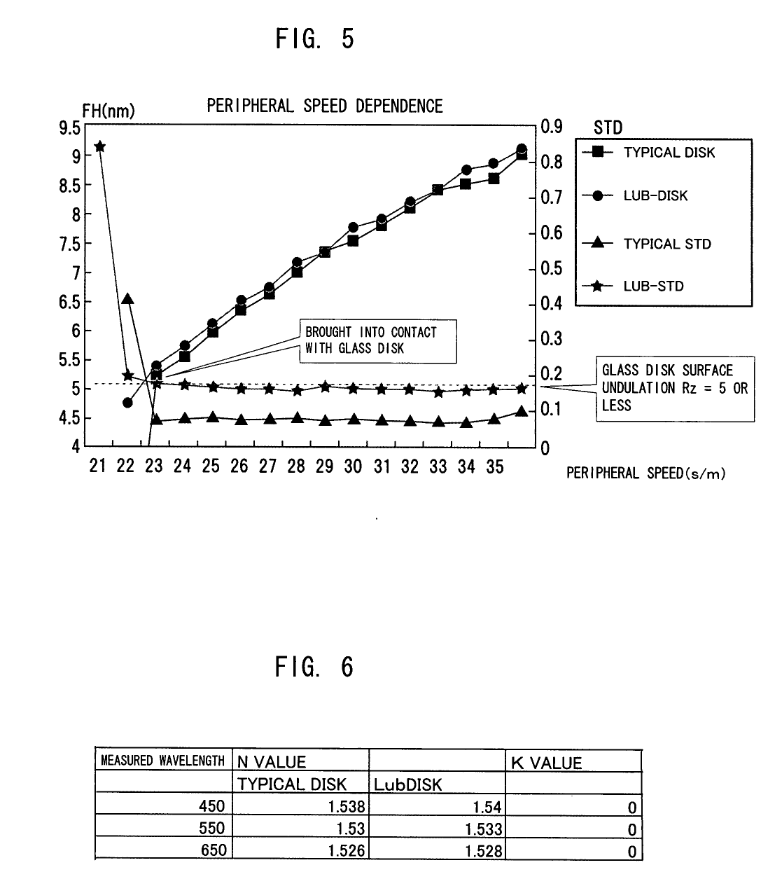

FIG. 5 is a graph showing a comparison between the glass disk according to the first embodiment and a conventional glass disk (typical disk) to which Lub coating has not been applied, with respect to a relationship between the peripheral speed of the glass disk and head levitation amount. The vertical axis of the graph represents peripheral speed. The left vertical axis represents levitation amount and corresponds to measurement results of “typical disk” and “LUB-disk”. The right vertical axis represents standard deviation of levitation amount and corresponds to measurement results of “typical STD” and “LUB-STD”. It is preferable for the levitation amount to exhibit monotonic increase relative to the peripheral speed. It is preferable for the standard deviation of levitation amount to be constant relative to the peripheral speed. As shown in the measurement result, according to the present invention, it is apparent that measurement can be performed up to low levitation amount area at which a distance between the glass disk 1 and magnetic head 2 is smaller than in the case where the typical disk is used while maintaining accuracy comparable to that of the other area (high levitation area).

FIG. 6 is a table showing a comparison between the glass disk 1 according to present embodiment used in the measurement shown in FIG. 5 and a typical disk, with respect to N value (reflectance) and K value (attenuation rate).

As is understood from the table, the N value and K value of the glass disk 1 according to the present embodiment are almost the same as those of the typical disk, even though Lub coating has been applied to the glass disk 1. Thus, optical detection accuracy of the glass disk 1 is not deteriorated.

Although the glass disk according to the first embodiment is used in FIGS. 5 and 6, almost the same measurement results have been obtained for the glass disk 2, which can easily be deduced from the measurement values shown in FIG. 6.

What is claimed is:

1. A transmissive disk for use in head levitation measurement, wherein
the transmissive disk has a first side of a transmissive plate to which AR coating has been applied and a second side thereof to which lubricant coating has been applied.

2. The transmissive disk according to claim 1, wherein
the lubricant coating is further applied to the upper surface of the first side to which AR coating has been applied.

3. The transmissive disk according to claim 1, wherein
the lubricant is fluorinated lubricant.

4. The transmissive disk according to claim 1, wherein
the transmissive plate is formed of a glass plate.

5. A manufacturing method of a transmissive disk for use in head levitation measurement, comprising:
applying AR coating to a first side of a transmissive plate; and
applying lubricant coating to a second side thereof.

6. The manufacturing method according to claim 5, further comprising:
applying AR coating to the first side of the transmissive plate; and
immersing the entire transmissive plate in lubricant.

7. A levitation measurement apparatus that performs head levitation measurement, comprising:
a transmissive disk;
a projector that is disposed opposite to a first side of the transmissive disk and project light, through the transmissive disk, to a head levitated from a second side of the transmissive disk; and
a measurement section that uses interference between light which is projected from the projector and reflected by the second side of the transmissive disk and light reflected by the head to measure a distance between the head and transmissive disk as a head levitation amount,
the transmissive disk having the first side of a transmissive plate to which AR coating has been applied and second side thereof to which lubricant coating has been applied.

8. The levitation measurement apparatus according to claim 7, wherein
the lubricant coating is further applied to the upper surface of the first side of the transmissive plate to which AR coating has been applied.

9. The levitation measurement apparatus according to claim 7, wherein
the lubricant is fluorinated lubricant.

10. The levitation measurement apparatus according to claim 7, wherein
the transmissive plate is formed of a glass plate.
